(19) United States
(12) Patent Application Publication
(10) Pub. No.: US 2024/0313530 A1
(43) Pub. Date: Sep. 19, 2024

(54) MOTORCYCLE JUMP-START SUPPORT SYSTEM

(71) Applicants: Stephen Hughington Thomas, Sebastian, FL (US); Tonya Sue Thomas, Sebastian, FL (US)

(72) Inventors: Stephen Hughington Thomas, Sebastian, FL (US); Tonya Sue Thomas, Sebastian, FL (US)

(21) Appl. No.: 18/121,659

(22) Filed: Mar. 15, 2023

(51) Int. Cl. H02J 1/10

(52) U.S. Cl. CPC H02J 1/122

(57) ABSTRACT

The invention is a motorcycle jump-start support system whose primary subsystem is an umbilical cable that attaches to a motorcycle battery's terminals and whose two-polarity connector resides outside the battery compartment and motorcycle seat such that it may be interfaced without having to remove the motorcycle seat once it has been installed. Its two-polarity connector is operative to ensure that accessory cables connected to it can only be connected in one orientation. Consequently, connecting a jumper accessory cable to the umbilical cable will preserve the correct connection polarity.

### TECHNICAL FIELD

The invention system facilitates jump-starting a motorcycle and charging or trickle-charging a motorcycle battery without having to remove the motorcycle's seat.

### BACKGROUND

Today's motorcycles essentially use batteries and alternators to start and provide power for virtually all motorcycle subsystems. Like automobiles and their electrical systems, if a motorcycle's battery discharges significantly, it may prevent starting the motorcycle much as a discharged automobile battery prevents starting an automobile.

With an automobile, however, the battery is readily accessible by opening the engine hood. A motorcycle, in contrast, typically has its battery located such that charging it, jumping it, or replacing it requires one to remove the motorcycle's seat which, in turn, requires the use of tools.

Motorcycle batteries because of vibration and infrequent use and normal chemical reactions typically last between three and five years. Within that time frame, it is possible that initial starting may be hampered by partially discharged batteries, or once started and driven, the battery no longer recharges well enough so that a later attempt to start the motorcycle may fail when the user is not near home and may not have the necessary tools for removing the seat.

A motorcycle that fails to start because of a partially discharged battery can be started by jumping it with another battery and using jumper cables. However, before being able to do so, typically, one must remove the seat and expose the battery's terminals. This is far less convenient than simply lifting an engine hood on an automobile.

### SUMMARY OF THE INVENTION SYSTEM

The invention system herein disclosed comprises an umbilical cable that permanently attaches to the motorcycle battery's terminals and is exposed outside of the motorcycle seat so that it can be accessed without removing the seat. Thus, the seat is removed in order to install the umbilical, and subsequently, it no longer needs to be removed.

The exposed umbilical connector provides a polarity-related means of connecting a jumper cable between another battery and the motorcycle's battery. Once thus connected, the motorcycle can typically be jump started and driven.

The exposed umbilical also provides a convenient means for connecting a battery charging system or battery tender system to the motorcycle's battery without having to remove either the seat or the battery. Consequently, the battery can be kept charged during periods of non-use of the motorcycle to overcome discharge due to internal chemical activity and always-on electronic subsystems.

It is important that the exposed portion of the umbilical be secured when not in use, and that its wires and connectors can handle the charging current and any heating that is likely to occur during a jump start or battery-charging cycle.

Accessory cables enable the umbilical to be connected to compatible jumper-type cables, to a compatible interface with battery chargers and/or battery tenders, and to allow two motorcycles equipped with the umbilical cables to be joined together, electrically, allowing one to provide the jump-starting power for the other.

### BRIEF DESCRIPTION OF THE DRAWINGS

FIG. 1 shows a motorcycle and the location of its battery.

FIG. 2 shows how with the seat removed the battery is accessible.

FIG. 3 shows an embodiment of the umbilical cable connected to the battery's terminals and ending in a connector that provides proper battery polarity interface with attached accessory cables.

FIG. 4 shows a motorcycle that has had the umbilical installed, the seat reattached, and a portion of the umbilical now accessible from outside the seat compartment.

FIG. 5 illustrates an embodiment of an accessory jump-start cable wherein one end has the usual alligator clips for connecting to another battery, and the other end has the mating connector that interfaces to the umbilical cable's connector.

FIG. 6 illustrates an embodiment of an accessory cable operative to connect to a battery charger or battery tender and to then interface with the umbilical cable.

FIG. 7 illustrates an embodiment of an accessory cable operative to connect the battery of one motorcycle to the battery of a second motorcycle by providing an interface between each motorcycle's umbilical cable.

### DETAILED DESCRIPTION

Today's motorcycles, like automobiles, rely on a battery and alternator to start the engine, and provide power to other subsystems. Like an automobile's battery, a motorcycle's battery has a limited lifetime and, as it ages, it becomes less capable of storing ample charge. When that occurs, the motorcycle may not start the motorcycle's engine, thereby leaving its driver stranded.

Automobiles may also fail to start due to significant battery discharge, but such vehicles are readily jump started by connecting jumper cables from a power source to the automobile's battery. Battery access is typically available as soon as the engine hood is opened.

In contrast, motorcycle batteries are not readily accessible. To gain access for charging or replacing these batteries, one must remove the motorcycle's seat, first, and reinstall it, later, when the work is completed, both of which require the use of tools.

Most motorcycle owners would be characterized as occasional users, and uses are punctuated by the motorcycle being parked. Under those circumstances, the battery will slowly discharge due to internal chemical reactions and current used to power always-on subsystems.

Many motorcyclists will remove the seat and connect a battery tender to the battery to keep it sufficiently charged. Other motorcyclists may remove the seat, remove the battery, and keep that battery trickle-charged to maintain the battery's capability.

In both cases, the user must remove the motorcycle seat, which requires tools, to gain access to the battery. This is both time consuming and inconvenient. It is even more so when a motorcycle is stranded and needs a jump start using jumper cables.

The invention herein disclosed is a support system that makes it far easier to access the motorcycle's battery in order to jump start the motorcycle or keep the battery charge at an optimal level. The system does so by having an umbilical cable permanently attached the battery such that by placing a portion of the umbilical cable outside the battery compartment and seat, the battery's terminals are accessible without having to remove and reinstall the seat, each time.

The portion of the umbilical cable that is located exterior to the battery compartment and seat is terminated in a connector the enforces proper polarity interface with any accessory cable and device. An asymmetric-shaped connector, like a puzzle piece, will only allow a mating connector having complementary asymmetry to interface with it. For example, one of the two wires making up the umbilical is connected to the battery's positive terminal, and the other to the battery's negative terminal. The attaching fixtures are suitably marked and/or color coded so that it is clear which wire is connected to which terminal. The connector at the opposite end of the umbilical is operative such that any accessory cable attached to it will have proper polarity connections to both the motorcycle's battery and to whatever the accessory cable is meant to be attached to it. So, for example, a red fixture on one end of the umbilical cable would attach to the battery's positive terminal, and any accessory cable that interfaces with that umbilical connector would result in a proper polarity connection, such as the alligator clip on a jumper cable that attaches to another battery's positive terminal. In similar fashion the interface cable for a battery charger/battery tender which interfaces to the motorcycle battery's positive terminal would be properly interfaced to the umbilical and its battery polarity interface. Finally, two motorcycles having the same type of umbilical cable could be linked to one another with an accessory cable having the same mating connector on both ends. In that way, using a second motorcycle to jump start a first one would be even more convenient than lifting the hood of an automobile and connecting jumper cables to its battery and the opposite-end connector to the umbilical. With the two motorcycles, it is simply a matter of connecting two mating plugs to the two umbilical connectors. Again, due to the polarization of the connectors, they can only be connected in one way ensuring proper battery and device polarities are maintained.

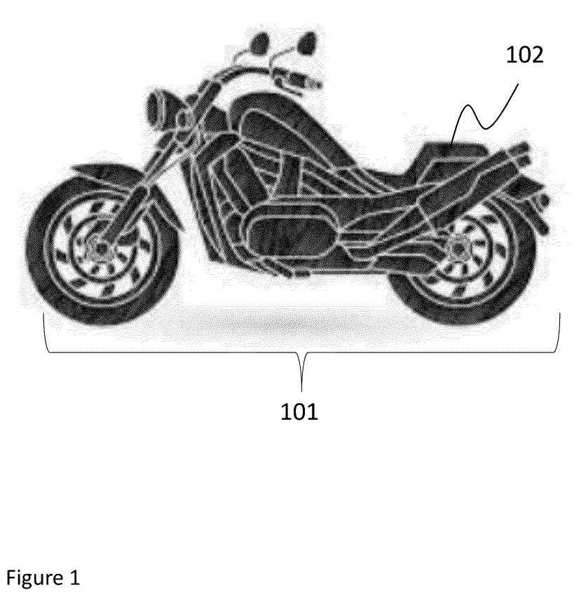

In FIG. 1, the motorcycle 101 is shown with the seat intact and the battery inside it 102.

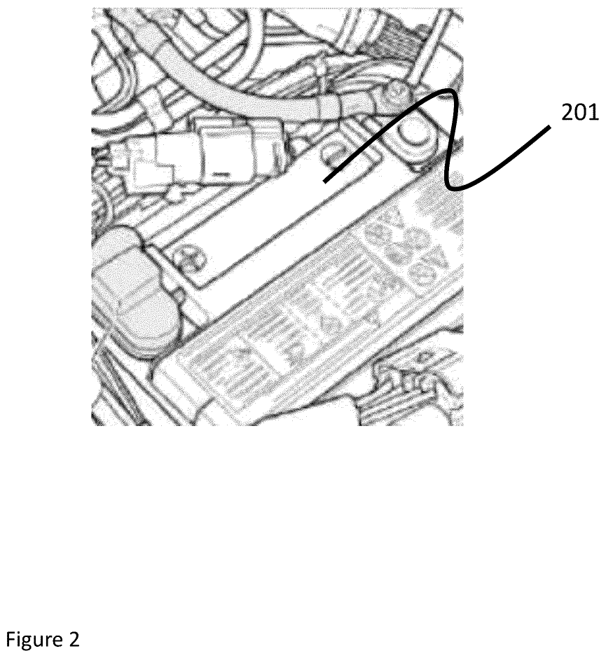

FIG. 2 shows the motorcycle after the seat has been removed such that the battery and its terminals are now accessible 201.

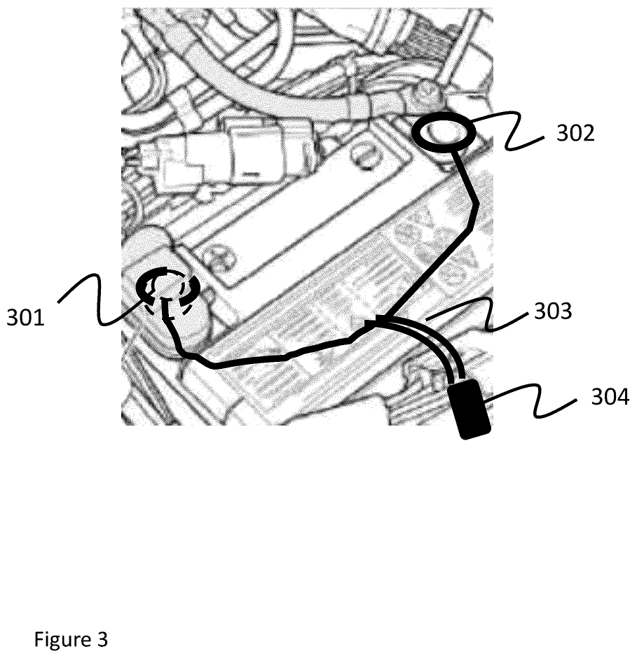

FIG. 3 shows an embodiment of the umbilical cable wherein a fixture 301 is used to connect the umbilical to the battery's positive terminal; a fixture 302 is used to connect the umbilical to the battery's negative terminal; two conducting wires 303 are attached, one each, to each fixture; and the opposite end of the two conductors terminates in a connector 304 operative to allow a mating connector to be attached in only one orientation thus assuring proper polarity interface.

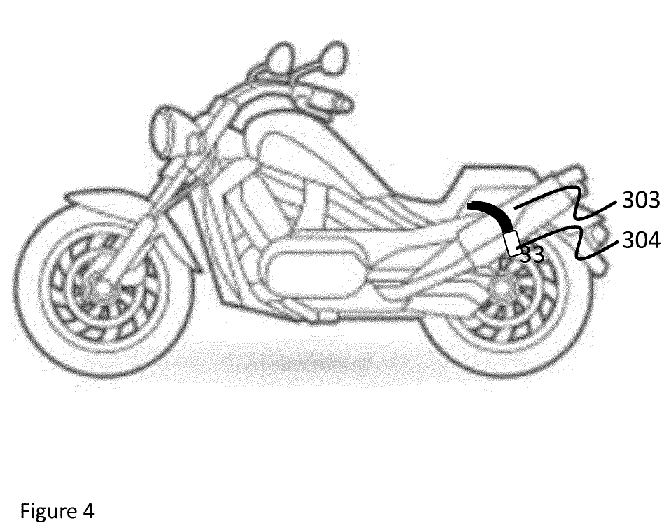

FIG. 4 shows an embodiment wherein the umbilical cable is oriented such that a portion of it is exposed outside of the battery compartment and seat, making it always accessible without removing the seat. Note that only a portion of the cable 303, and the terminating connector 304, reside outside the seat.

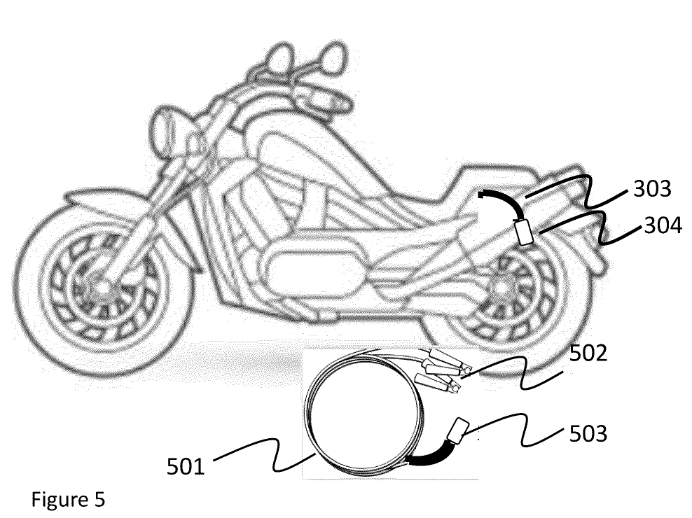

In FIG. 5, an accessory jumper cable embodiment 501 features the conventional alligator clips on one end of the cable 502 and a mating connector 503 operative to interface with the umbilical cable's connector in only one orientation, so as to ensure proper polarity.

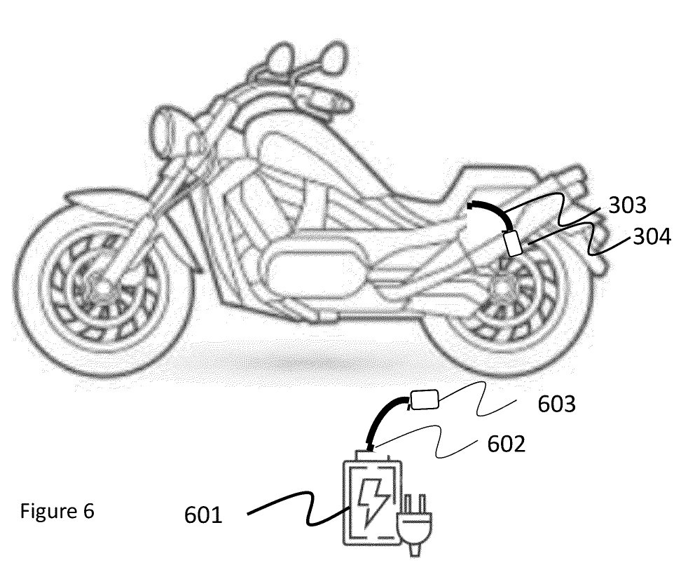

In FIG. 6, an accessory cable 602 as part of a battery charger or battery tender 601 terminates in a mating connector that is operative to interface with the umbilical cable's connector in only one orientation, so as to ensure proper polarity.

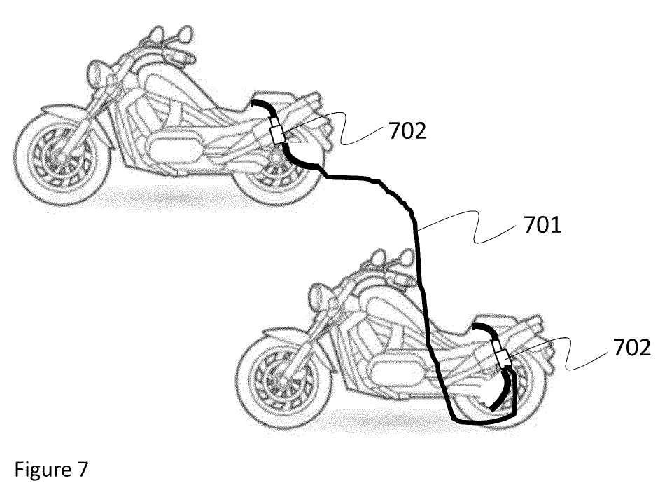

FIG. 7 shows an embodiment of an accessory cable 701 operative to join two umbilical cables, connected one each to each of two motorcycles. In this way, one motorcycle whose battery is operable can provide a jump start to a second motorcycle whose battery fails to start the machine. Note that in this case, the interface involves simply plugging a connector 702 on each end of the accessory cable to its mating connector on the respective umbilical cable.

Cable lengths are not critical so long as wire gauge is sufficient to reduce resistive loss to a case where no more than 0.5 volt of IR loss is lost in the cable. Polarizing connectors are available that can be used to terminate these accessory and umbilical cables. These connectors should be robust and be able to handle the maximum charging currents likely to be experienced when jump starting or charging a fully discharged battery. These terminating connectors should prevent even forceful attempts to join them where the mating connectors are not in proper orientation.

Note that all drawings are meant to be exemplary and should not be read as limiting the scope or implementation of the system. The fixtures on one end of the umbilical cable may be types that clamp onto the battery terminals or are adapted to attach firmly to other fixtures that are connected to the battery terminals.

Note that the umbilical and accessory cables may be implemented using low-resistivity, stranded, wires made of copper, aluminum or a blend of conducting materials.

What is claimed is:

1. A system for supporting jump-starting of a motorcycle comprising:
an umbilical cable;
a jumper cable;
the umbilical cable comprises a two-conductor, insulated, wire portion;
the umbilical cable has two fixtures on one end operative to be firmly attached to a motorcycle's battery's terminals;
the umbilical cable has a two-polarity connector on its opposite end operative to interface with an accessory cable having a mating connector, and operative to be joined by arranging the connector and mating connector in only one orientation;
the jumper cable comprises a two-conductor, insulated, wire portion;
the jumper cable has on one end attachment structures operative to temporarily attach each attachment structure to each battery terminal on a jump-start power source; and
the jumper cable has on the opposite end the mating connector operative to interface with the connector on the umbilical cable when inserted in only one orientation.

2. A claim as in claim 1 further comprising:
a battery-charger/battery-tender interface accessory cable comprising a two-conductor, insulated, wire portion;
the battery-charger/battery-tender interface accessory cable has on one end a battery-charger/battery-tender interface connector compatible with the interface connector of the battery-charger/battery-tender device; and
the battery-charger/battery-tender interface accessory cable has on its opposite end a mating connector operative to interface with the connector on the umbilical cable when inserted in only one orientation.

3. A claim as in claim 1 further comprising:
an umbilical-to-umbilical interface accessory cable comprising a two-conductor, insulated, wire portion; and
the umbilical-to-umbilical interface accessory cable has on both ends the mating connector operative to interface with the connector on the umbilical cable when inserted in only one orientation.

4. A claim as in claim 1 wherein:
the two-conductor, insulated, wire portion is made of stranded copper wire.

5. A claim as in claim 1 wherein:
the two-conductor, insulated, wire portion is made of stranded aluminum wire.

6. A claim as in claim 1 wherein:
the two-conductor, insulated, wire portion is made of a blend of stranded copper and aluminum wires.

7. A claim as in claim 2 wherein:
the two-conductor, insulated, wire portion is made of stranded copper wire.

8. A claim as in claim 2 wherein:
the two-conductor, insulated, wire portion is made of stranded aluminum wire.

9. A claim as in claim 2 wherein:
the two-conductor, insulated, wire portion is made of a blend of stranded copper and aluminum wires.

10. A claim as in claim 3 wherein:
the two-conductor, insulated, wire portion is made of stranded copper wire.

11. A claim as in claim 3 wherein:
the two-conductor, insulated, wire portion is made of stranded aluminum wire.

12. A claim as in claim 3 wherein:
the two-conductor, insulated, wire portion is made of a blend of stranded copper and aluminum wires.

13. A claim as in claim 1 wherein:
the fixtures on one end of the umbilical cable are operative to be attached directly to the motorcycle's battery terminals.

14. A claim as in claim 1 wherein:
the fixtures on one end of the umbilical cable are operative to be firmly attached to another attachment fixture that is directly attached to the motorcycle's battery terminal.

15. A claim as in claim 2 wherein:
the battery-charger/battery-tender accessory cable is operative to interface with a cable of the battery-charger/battery-tender device.

16. A claim as in claim 1 wherein:
the jumper-cable attachment fixtures are comprised of copper metal.

17. A claim as in claim 1 wherein:
the jumper-cable attachment fixtures are comprised of aluminum metal.

18. A claim as in claim 1 wherein:
the jumper-cable attachment fixtures are comprised of copper alloy.

19. A claim as in claim 1 wherein:
the two-polarity connector is asymmetric such that a mating connector can only interface to it in one orientation.

20. A claim as in claim 2 wherein:
the two-polarity connector is asymmetric such that a mating connector can only interface to it in one orientation.

21. A claim as in claim 3 wherein:
the two-polarity connector is asymmetric such that a mating connector can only interface to it in one orientation.
